(19) United States
(12) Patent Application Publication
(10) Pub. No.: US 2017/0315290 A1
(43) Pub. Date: Nov. 2, 2017

(54) DISPLAY APPARATUS

(71) Applicant: Samsung Display Co., Ltd., Yongin-Si (KR)

(72) Inventors: Min-young SONG, Asan-si (KR); Seul-gi KIM, Seoul (KR); Eunju NAM, Seoul (KR); Woosuk SEO, Yongin-si (KR)

(21) Appl. No.: 15/497,360

(22) Filed: Apr. 26, 2017

(30) Foreign Application Priority Data
May 2, 2016 (KR) 10-2016-0054166

(51) Int. Cl. F21V 8/00

(52) U.S. Cl. CPC G02B 6/0031; G02B 6/0088; G02B 6/0055; G02B 6/0065

(57) ABSTRACT

A display apparatus includes: a display panel displaying an image, including a display area at which the image is displayed, and a non-display area which surrounds the display area; and a backlight unit which provides light to the display panel. The backlight unit includes: a light guide plate under the display panel and guiding the light; a light source generating the light and disposed at a side of the light guide plate; a coupling member coupling the display panel to the light guide plate, and disposed in the non-display area and between the display panel and the light guide plate; and a reflection member. The coupling member includes a first end facing the display panel and a second end opposing the first end thereof and facing the light guide plate. The reflection member disposed on the first end or the second end of the coupling member.

This application claims priority to Korean Patent Application No. 10-2016-0054166, filed on May 2, 2016, and all the benefits accruing therefrom under 35 U.S.C. §119, the content of which in its entirety is hereby incorporated by reference.

### BACKGROUND

### (1) Field

The present disclosure relates to a display apparatus, and more particularly, to a display apparatus having improved light efficiency.

### (2) Description of the Related Art

A light receiving type display apparatus which displays an image includes a liquid crystal display device, an electrowetting display device and an electrophoretic display device. The aforementioned display devices include a separate backlight unit which generates and provides light to a display panel which generates and displays the image.

Among the aforementioned display devices, the liquid crystal display device has secured a firm market by advanced mass production technology and advantages thereof such as relative ease of driving means, low power consumption, slim thickness, and implementation of high picture quality and a large display screen. Further, fields in which the liquid display device is applied are expanding.

With the development of technology for display apparatuses, research and development for providing products having various designs to consumers are emphasized.

### SUMMARY

One or more embodiment of the invention provides a relative slim display apparatus having a minimized overall thickness.

One or more embodiment of the invention also provides a display apparatus having improved light efficiency.

An embodiment of the invention provides a display apparatus including a display panel and a backlight unit which is disposed under the display panel.

In an embodiment, the display panel is configured to provide an image with light, and includes a display area at which the image is displayed, and a non-display area which surrounds the display area and at which the image is not displayed.

In an embodiment, the backlight unit includes a light guide plate which is disposed under the display panel and guides the light, a light source which generates and provides the light, the light source disposed at a side of the light guide plate, a coupling member and a reflection member.

In an embodiment, the coupling member couples the display panel to the light guide plate, is disposed in the non-display area and between the display panel and the light guide plate, and includes a first end facing the display panel and a second end opposing the first end thereof and facing the light guide plate. In an embodiment of the present disclosure, the coupling member may surround the display area, in a top plan view.

In an embodiment, the reflection member is disposed on the first or second end of the coupling member. The reflection member may be disposed in the non-display area. The reflection member may include a reflective material, and the reflective material may include silver (Ag) or aluminum (Al).

In an embodiment, the non-display area may be divided into a first non-display area and a second non-display area. The first non-display area may be extended along the side of the light guide plate at which the light source is disposed. The second non-display area may be connected to the first non-display area and extend along remaining sides of the light guide plate to surround the display area.

In an embodiment, the light guide plate may include glass. The light guide plate may include a light emitting surface facing the display panel, an opposed surface opposed to the light emitting surface, and a light incident surface facing the light sources and connecting the light emitting surface to the opposed surface.

In an embodiment, the reflection member disposed in the first non-display area may be on the light emitting surface of the light guide plate and between the coupling member and the light emitting surface of the light guide plate to contact the second end of the coupling member. A total planar area of the reflection member disposed in the first non-display area may be equal to or greater than a total planar area of the second end of the coupling member in a top plan view.

In an embodiment, the display apparatus may further include an optical sheet disposed between the display panel and the light guide plate and including a side thereof facing the coupling member. The reflection member may extend further than the coupling member to be disposed between the light guide plate and the optical sheet.

In another embodiment of the invention, the reflection member may be on a rear surface of the display panel opposite to a display surface thereof. The reflection member may be disposed between the coupling member and the display panel and contact the first end of the coupling member. A total planar area of the reflection member disposed in the first non-display area is equal to or greater than a total planar area of the first end of the coupling member in a top plan view. The reflection member may extend further than the coupling member to be disposed between the display panel and the optical sheet.

In another embodiment, the coupling member may include a first coupling portion disposed extended in the first non-display area extended along the side of the light guide plate at which the light source is disposed; and a second coupling portion disposed extended in the second non-display area extended along the remaining sides of the light guide plate to surround the display area.

In another embodiment, the light source may be provided in plurality spaced apart from each other along the side of the light guide plate to be arranged in a first direction. The first coupling portion disposed extended in the first non-display area may include: a first sub-coupling portion provided in plurality spaced by a predetermined distance from each other and arranged along the side of the light guide plate at which the light source is disposed to be arranged in the first direction; and a second sub-coupling portion disposed spaced by a predetermined distance from outermost first sub-coupling portions at opposing ends of the side of the light guide plate at which the light source is disposed. The second sub-coupling portions at the opposing ends of the side of the light guide plate may each be bent at least once to be coupled to the second coupling portion disposed extended in the second non-display area.

In another embodiment, in a second direction intersecting the first direction in a top plan view, the first sub-coupling portions arranged spaced apart in the first direction are disposed at spaces defined between the light sources spaced apart from each other in the first direction. In the second direction intersecting the first direction in the top plan view, the first and second sub-coupling portions arranged spaced apart in the first direction do not overlap the light sources arranged spaced apart in the first direction.

In another embodiment, the reflection member may include a reflective material and be a reflection tape or a printed layer.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is a perspective view of an embodiment of a display apparatus according to the invention;

FIG. 2 is a cross-sectional view of the display apparatus taken along line I-I′ of FIG. 1;

FIG. 3 is an enlarged cross-sectional view of the display apparatus at portion AA′ of FIG. 2;

FIG. 4 is a top plan view of a portion of an embodiment of a display apparatus according to the invention;

FIG. 5 is a top plan view of a portion of another embodiment of a display apparatus according to the invention;

FIG. 6 is a cross-sectional view of still another embodiment of a display apparatus according to the invention; and

FIG. 7 is an enlarged cross-sectional view of the display apparatus at portion BB′ of FIG. 6.

### DETAILED DESCRIPTION

The embodiments according to the invention may be variously modified and may have multiple forms, and thus specific embodiments are illustrated in the drawings or described in detail in this specification. However, this is not intended to limit the invention to the specific embodiments, rather it should be understood that all of variations, equivalents or substitutes contained in the concept and technical scope of the invention are also included.

Herein, the term “comprise” or “have” intends to mean that there may be specified features, numerals, steps, operations, elements, parts, or combinations thereof, not excluding the possibility of the presence or addition of the specified features, numerals, steps, operations, elements, parts, or combinations thereof. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items.

When a layer, film, area or substrate is referred to as being ‘on’ another layer, film, area or substrate, it can be directly on the other layer, film, area or substrate, or intervening layers, films, areas or substrates may also be present. When a layer, film, area or substrate is referred to as being ‘under’ another layer, film, area or substrate, it can be directly under the other layer, film, area or substrate, or intervening layers, films, areas or substrates may also be present. To the contrary, when a layer, film, area or substrate is referred to as being ‘directly on’ or ‘directly under’ another layer, film, area or substrate, no intervening layers, films, areas or substrates may are present.

In describing figures, like reference numerals refer to like elements. In the accompanying figures, the dimensions of structures are exaggerated for clarity of illustration. Terms ‘first’, ‘second’ etc. may be used to describe various elements, but the elements should not be limited by these terms. These terms are merely used for the purpose of discriminating one element from another element. For example, the first element may be designated as the second element and vice versa. A singular form, otherwise indicated, include a plural form.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, embodiments of the invention will be described in detail with reference to the accompanying drawings.

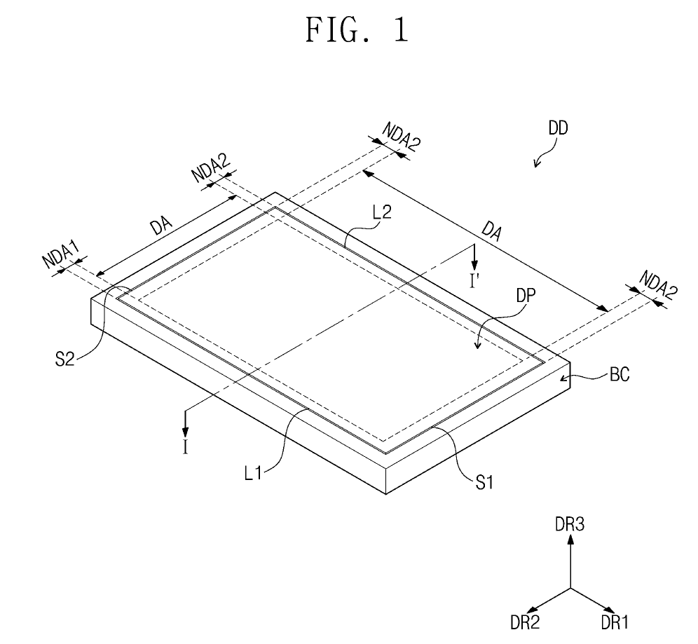

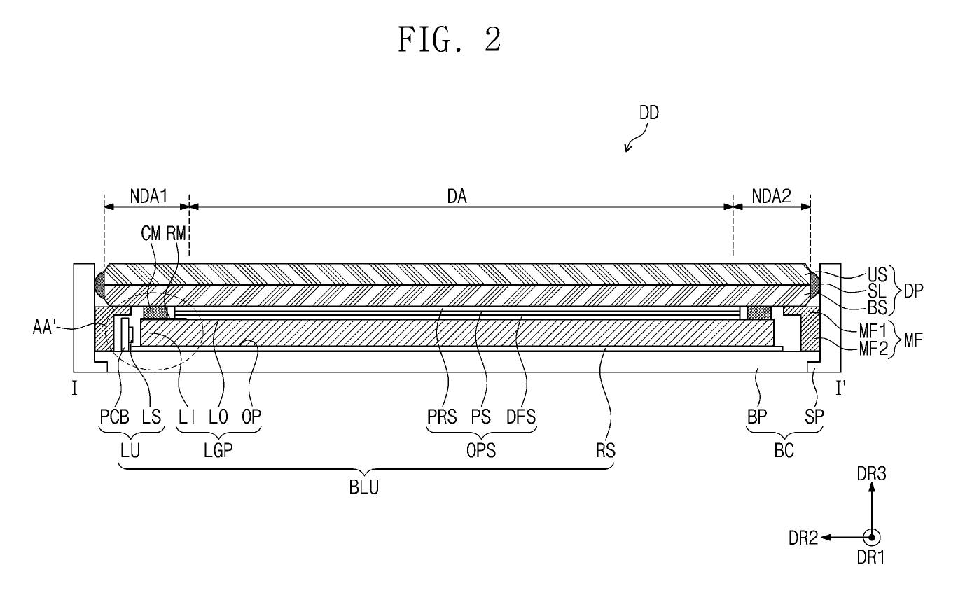

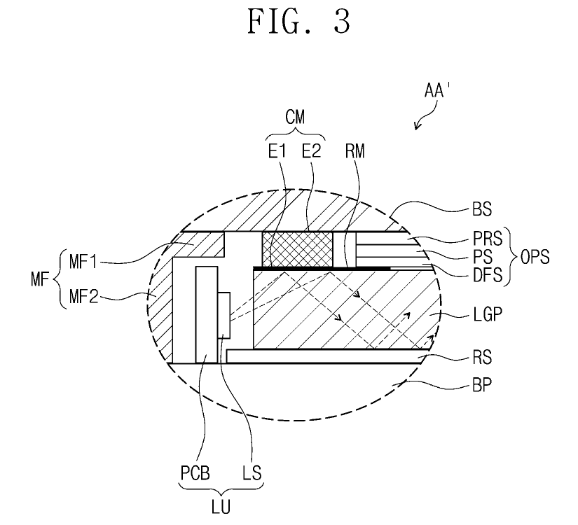

FIG. 1 is a perspective view of an embodiment of a display apparatus according to the invention, and FIG. 2 is a cross-sectional view of the display apparatus taken along line I-I′ of FIG. 1. FIG. 3 is an enlarged cross-sectional view of the display apparatus at portion AA′ of FIG. 2.

First, referring to FIGS. 1 and 2, an embodiment of a display apparatus DD may include a display panel DP, a backlight unit BLU, a mold frame MF and a bottom chassis BC. Herein, a direction in which an image is provided from the display apparatus DD is referred to as an upper direction and an opposite direction to the upper direction is referred to as a lower direction for the convenience of explanation. However, the upper or lower direction is a relative concept, and may be changed to another direction.

The display panel DP may receive light generated and from the backlight unit BLU to generate and display an image. The display panel DP may provide the image through a display surface in a plane defined by a first direction DR1 and a second direction DR2 which intersects the first direction DR1. The upper direction in which the image is provided is described as a third direction DR3 which is perpendicular to the first and second directions DR1 and DR2.

The display panel DP, which is a light receiving type display panel, may be a liquid crystal display (“LCD”) panel, an electrowetting display panel, an electrophoretic display panel or a microelectromechanical system (“MEMS”) display panel, but is not limited thereto. Hereinafter, an LCD panel will be used as an exemplary display panel for describing the embodiments of the invention.

The display panel DP may be provided in a rectangular planar shape having two pairs of parallel sides. In an embodiment, the display panel DP may be provided in a rectangular shape having a first long side L1 and a second long side L2 which define lengths thereof extending in the first direction DR1 and a first short side Si and a second short side S3 which define lengths thereof extending in the second direction DR2.

In an embodiment of the invention, although a planar (e.g., flat) display panel is illustrated as an example of the display panel DP, the invention is not limited thereto. In another embodiment, the display panel DP may be provided in a curved shape with respect to one direction or more than one direction.

A total planar area of the display panel DP may be defined by a display area DA at which an image is displayed and a non-display area NDA which surrounds the display area DA at which the image is not displayed. The display area and the non-display area of the display apparatus DD may correspond to those areas of the display panel DP. A total planar area of the non-display area of the display apparatus DD may be larger than that of the display panel DP, owing to other components of the display apparatus DD such as the bottom chassis BC, etc.

In this embodiment, the non-display area NDA may be divided into a first non-display area NDA1 corresponding to the first long side L1 and a second non-display area NDA2 other than the first non-display area NDA1, that is, corresponding to a remainder of the long and short sides of the display panel DP. The first and second non-display areas NDA1 and NDA2 are connected to each other and together form an overall non-display area.

The display panel DP may include an upper substrate US, a lower substrate BS, and a liquid crystal layer (not shown) disposed between the upper substrate US and the lower substrate BS.

The lower substrate BS includes a pixel provided in plurality (not shown) therein such as on a base substrate of the lower substrate BS. The pixels are arranged within the display area DA. Each of the pixels may include at least one thin film transistor (not shown) and a pixel electrode (not shown) connected to the thin film transistor. The pixel is a display unit at which the image is generated.

The upper substrate US may include a common electrode (not shown) therein such as on a base substrate of the upper substrate US. The common electrode forms an electric field together with the pixel electrode of the lower substrate to control liquid crystals of the liquid crystal layer. The display panel DP may drive the liquid crystal layer to provide an image in the third direction DR3.

The display panel DP may further include a sealing member SL disposed on a side surface of the upper and/or lower substrates US and BS, such as at an interface thereof. The sealing member SL may reduce or effectively prevent a foreign matter from being introduced between the upper substrate US and the lower substrate BS. Also, the sealing member SL may protect the side surfaces of the upper and lower substrates US and BS from external impact thereto. However, in al alternative embodiment, the sealing member SL may be omitted if necessary.

The backlight unit BLU generates and provides light to the display panel DP, and is provided under the display panel DP. The backlight unit BLU may include a light source unit LU, a light guide plate LGP, a coupling member CM, a reflection member RM, an optical sheet OPS and a reflective sheet RS.

The light source unit LU generates and provides the light, and may be disposed adjacent to at least one side of the light guide plate LGP. In this embodiment, it is described as an example that the light source unit LU is disposed at a location corresponding to the first long side L1, but the invention is not limited thereto. The light source unit LU may include a light source LS and a printed circuit board PCB. The light source LS may be provided in plurality on the printed circuit board PCB.

The light sources LS may be surface mounted on an upper surface of the printed circuit board PCB which faces the light guide plate LGP, spaced apart by a predetermined distance from each other along the first direction DR1 (e.g., length of the printed circuit board PCB). Light generated and emitted from the light sources LS may be incident into the light guide plate LGP at a side thereof corresponding to the first long side L1 of the display panel DP. In an embodiment, it is illustrated as an example that a light emitting diode (“LED”) is used as a point light source among the light sources LS. The light sources LS may be provided as individual LEDs, respectively, or an LED group provided in plurality each including more than one LED.

A wiring (not shown) for supplying power to the light sources LS and controlling the light sources LS is disposed such as by printing a conductive wiring material on the printed circuit board PCB. The printed circuit board PCB may include a light source controller (not shown) connected to the light sources LS. The light source controller (not shown) may be mounted on a separate printed circuit board, but the location thereof is not particularly restricted.

The light guide plate LGP is disposed under the display panel DP and guides light incident into the light guide plate LGP from the light source unit LU toward the display panel DP. The light guide plate LGP may include or be made of a transparent polymer resin, such as polycarbonate or polymethyl methacrylate, or glass. In this embodiment, it is described as an example that the light guide plate LGP is made of glass.

The light guide plate LGP may include a light emitting surface LO, an opposed surface OP and a light incident surface LI. The light guide plate LGP may provide the light, which is transmitted through the light emitting surface LO, to outside the light guide plate LGP. The light emitting surface LO may be a surface disposed in a plane parallel to that of the display panel DP. The opposed surface OP is opposite to the light emitting surface LO. The opposed surface OP may be disposed under the light emitting surface LO in a thickness direction (e.g., third direction DR3) of the display apparatus DD.

The light guide plate LGP may receive light emitted from the light source unit LU, through the light incident surface LI. The light incident surface LI may be a surface facing the light source unit LU among side surfaces connecting the light emitting surface LO and the opposed surface OP of the light guide plate LGP to each other.

Referring to FIGS. 2 and 3, the light guide plate LGP may be fixedly connected to the display panel DP. The coupling member CM may be disposed between the display panel DP and the light guide plate LGP and connect the display panel DP to the light guide plate LGP. The coupling member CM may overlap the non-display area, when viewed in the top plane view. The coupling member CM includes a first (lower) end E1 facing the light guide plate LGP and a second (upper) end E2 facing the display panel DP.

The reflection member RM reduces or effectively prevents light incident into the light guide plate LGP from being deteriorated by the coupling member CM, and may be disposed at the first end E1 and/or the second end E2 of the coupling member CM. In this embodiment, it is described as an example that the reflection member RM is disposed only on the first end E1.

The reflection member RM may be disposed at a portion of the light emitting surface LO overlapping the first non-display area NDA1. The reflection member RM includes a reflective material, and may include at least any one of silver (Ag) and aluminum (Al).

The reflection member RM may be a coating layer which is coated on the light guide plate LGP with the reflective material, but not limited thereto. In another embodiment, the reflection member RM may be a reflective tape or a printed layer including the reflective material.

The reflection member RM is disposed between the coupling member CM and the light guide plate LGP, and may contact the first end E1 of the coupling member CM.

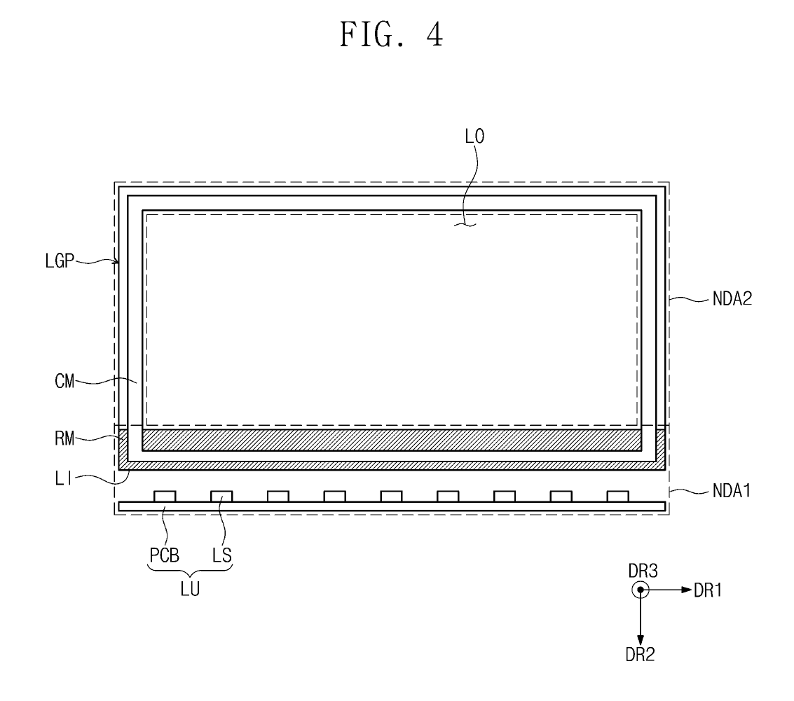

FIG. 4 is a top plan view of a portion of a display apparatus according to the invention. Hereinafter, the coupling member CM and the reflection member RM will be described in more detail with reference to FIG. 4. Although the display panel DP is not illustrated in FIG. 4, the first and second non-display areas NDA1 and NDA2 of the display panel DP are illustrated with a dotted line, for the convenience of explanation.

As illustrated in FIG. 4, the coupling member CM may be disposed at an edge of the light emitting surface LO. The coupling member CM defines lengths thereof which extends along an extension direction (e.g., length) of the non-display area, and may overlap both the first and second non-display areas NDA1 and NDA2. The coupling member CM may be disposed so as to surround the display area DA, when viewed in the top plan view. The coupling member CM may have an overall quadrangular ring shape.

A total planar area of the reflection member RM may be greater than that of the first end E1 of the coupling member CM disposed in the first non-display area NDA1, when viewed in the top plan view, but not limited thereto. In another embodiment, the total planar area of the reflection member RM may be equal to that of the first end E1 of the coupling member RM disposed in the first non-display area NDA1.

Referring to FIG. 2 again, the optical sheet OPS may be disposed between the display panel DP and the light guide plate LGP. The optical sheet OPS serves to control the light emitted from the light sources LS, guided by the light guide plate LGP and emitted therefrom. The optical sheet OPS may include an upper surface facing the display panel DP, a lower surface opposite to the upper surface, and side surfaces connecting the upper and lower surfaces to each other. At least one side (surface) of the optical sheet OPS may face the coupling member CM. In this embodiment, the optical sheet OPS may be surrounded by the coupling member CM, when viewed in the top plan view.

A portion of the reflection member RM other than the portion of the reflection member RM overlapping the first end E1 may be disposed between the optical sheet OPS and the light guide plate LGP. That is, the reflection member RM may extend further than the coupling member CM and toward the optical sheet OPS to be disposed between the optical sheet OPS and the light guide plate LGP.

The optical sheet OPS may include a diffusion sheet DFS, a prism sheet PS and a protection sheet PRS, and these sheets may be laminated together on the light guide plate LGP to collectively form the optical sheet OPS.

The diffusion sheet DFS diffuses light. The prism sheet PS serves to concentrate the light diffused by the diffusion sheet DFS in a direction perpendicular to the planar surface of the display panel DP. Most of the light passing the prism sheet PS is perpendicularly incident into the display panel DP.

The protection sheet PRS may be disposed on the prism sheet PS. The protection sheet PRS may protect the prism sheet PS from an external impact thereto. In this embodiment, although it is described as an example that the optical sheet OPS has one diffusion sheet DFS, one prism sheet PS and one protection sheet PRS, the invention is not limited thereto. In another embodiment, for example, the optical sheet OPS may be configured such that at least any one of the diffusion sheet DFS, the prism sheet PS and the protection sheet PRS is provided in plurality to be two or more sheets, and at least any one of the diffusion sheet DFS, the prism sheet PS and the protection sheet PRS is omitted if necessary. Further, the diffusion sheet DFS, the prism sheet PS and the protection sheet PRS may be stacked in a different stacking order than that illustrated.

The reflection sheet RS may be disposed under the light guide plate LGP. The reflection sheet RS may be a substrate or film including or made of polyethylene terephthalate (“PET”) and including a light reflective material such as aluminum (Al). The reflection sheet RS may serve to reflect light, which is not emitted through the light emitting surface LO of the light guide plate LGP but leaks to the reflection sheet RS through the opposed surface OP, so that the light is re-incident into the light guide plate LGP again. Since the reflection sheet RS is provided, loss of light provided to the display panel DP may be reduced by the reflection sheet RS.

The mold frame MF may be disposed between the display panel DP and the bottom chassis BC. The mold frame MF may be disposed under the display panel DP and support the display panel DP. Further, the mold frame MF may also fix the location of the light source unit LU. The mold frame MF may include a first mold frame portion MF1 and a second mold frame portion MF2. The first mold frame portion MF1 may extend to overlap the non-display area NDA and support the display panel DP thereon. The second mold frame portion MF2 may be bent from the first mold frame MF1 and extend in a direction opposite to the third direction DR3, such as along a side surface of the light guide plate LGP. One of the first and second mold frame portions MF1 and MF2 may extend to define the other one of the first and second mold frame portions MF1 and MF2.

The bottom chassis BC may accommodate the backlight unit BLU and the mold frame MF therein. The bottom chassis BC may include a bottom portion BP disposed under the reflection sheet RS and a sidewall portion SP which is connected to the bottom portion BP.

The bottom portion BP may be provided in a planar shape disposed in a plane which is parallel to a planar surface formed by the first and second directions DR1 and DR2. The sidewall portion SP extends in the third direction DR3 from the bottom portion BP to define a predetermined inner (receiving) space together with the bottom portion BP. The sidewall portion SP may be provided integrated in the bottom portion BP, or configured to be assembled to and detachable from the bottom portion BP. In an integrated assembly, one of the bottom and sidewall portions BP and SP may extend to define the other one of the bottom and sidewall portions BP and SP.

Since one or more embodiment of the display apparatus DD according to the invention employs the light guide plate LGP including or made of glass, curving or deformation of the light guide plate LGP due to heat generated within the display apparatus DD such as by the display panel DP may be reduced or effectively prevented, even though the light guide plate LGP is connected to the display panel DP. Accordingly, since the curving or deformation of the light guide plate LGP may be reduced or effectively prevented, it is possible to make the light guide plate LGP slim (e.g., having an overall minimized thickness) and to apply the slim light guide plate LGP to the display apparatus DD, thus making the display apparatus DD slim (e.g., having an overall minimized thickness).

Since lengths of the coupling member CM are disposed along lengths (e.g., extension directions) of portions of the non-display area, the coupling member CM may enhance the contact force between the light guide plate LGP and the display panel DP at the non-display area. Therefore, one or more embodiment of the coupling member CM within the display apparatus DD may reduce a phenomenon that the light guide plate LGP is delaminated from the display panel DP.

Although the coupling member CM is disposed so as to overlap the first non-display area NDA1 adjacent to the light source unit LU, the reflection member RM is disposed between the coupling member CM at the light incident surface LI of the light guide plate LGP and the light guide plate LGP, and thus is able to reduce or effectively prevent the light incident into the light guide plate LGP from being lost through the coupling member CM. Further, the reflection member RM may reduce or effectively prevent a phenomenon that the light incident into the light guide plate LGP leaks to the outside of the display panel DP through a side surface of the optical sheet OPS. Thus, the display apparatus DD having improved light efficiency may be provided.

Hereinafter, another embodiment of a display apparatus according to the invention will be described with reference to the attached drawings. For convenience of explanation, these other embodiments will be described centered on different components from those of the foregoing embodiments, and components that are not described for these other embodiments will be appreciated as being the same as those of the foregoing embodiments. Also, the same reference numerals will be given to the same components as those described above, and a duplicate description thereof will be omitted.

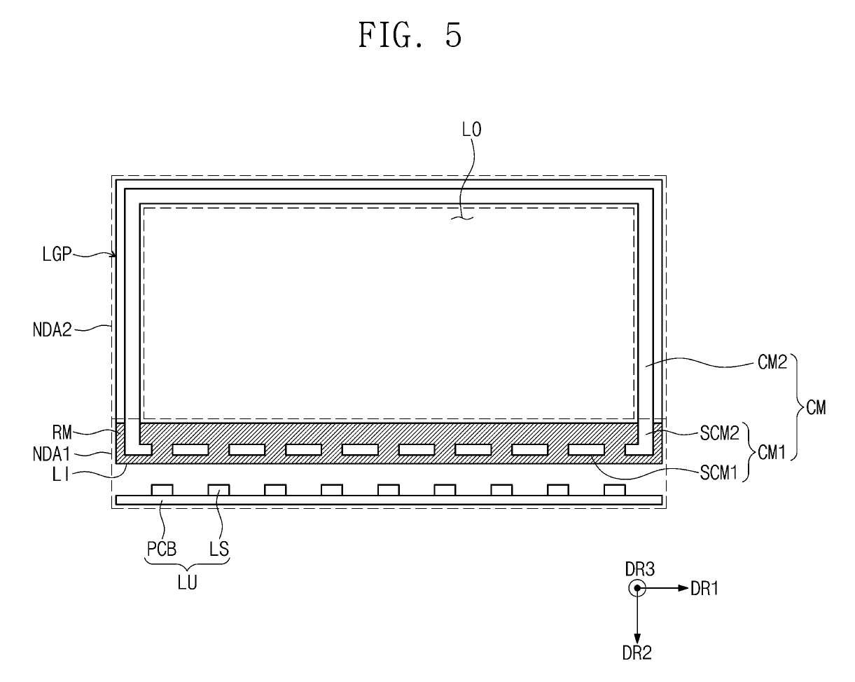

FIG. 5 is a top plan view of a portion of another embodiment of a display apparatus according to the invention. Hereinafter, another embodiment of a coupling member CM and a reflection member RM according to the invention will be described in detail with reference to FIG. 5. The display panel DP is not illustrated in FIG. 5, but the first non-display area NDA1 and the second non-display area NDA2 of the display panel DP are illustrated with a dotted line, for convenience of explanation.

Referring to FIG. 5, the coupling member CM may include a first coupling portion CM1 overlapping the first non-display area NDA1 and a second coupling portion CM2 overlapping the second non-display area NDA2.

In the first non-display area NDA1 at the light incident surface LI of the light guide plate LGP, the first coupling portion CM1 may include a discrete first sub-coupling portion SCM1 provided in plurality arranged in the first direction DR1 and spaced by a predetermined distance from each other. In the first non-display area NDA1 at the light incident surface LI of the light guide plate LGP, the first coupling portion CM1 may include a second sub-coupling portion SCM2 disposed spaced by a predetermined distance in the first direction DR1 from the first sub-coupling portion SCM1. The second sub-coupling portion SCM2 may be provided in plural adjacent to outermost first sub-coupling portions SCM1 at opposing ends of the side of the light guide plate LGP.

The first sub-coupling portions SCM1 may be projected or exposed in the second direction DR2 through a space between light sources LS that are adjacent to each other among the light sources LS, when viewed in the top plan view. That is, the first sub-coupling portions SCM1 may be alternated with the light source LS along the first direction DR1. In FIG. 5, the first sub-coupling portion SCM1 is illustrated in a rectangular planar shape defining a length thereof which extends in the first direction DR1 and a width thereof which extends in the second direction DR2 to be smaller than the length, but is not limited thereto. In another embodiment, the first sub-coupling portion SCM1 may be provided in various planar shapes.

The second sub-coupling portion SCM2 may be bent at least once in the first non-display area NDA1 and coupled to the second coupling portion CM2 disposed in the second non-display area NDA2. One of the second sub-coupling portion SCM2 and the second coupling portion CM2 may be extended to define the other one of the second sub-coupling portion SCM2 and the second coupling portion CM2. In FIG. 5, it is illustrated that the second sub-coupling portion SCM2 is bent once, but not limited thereto. In another embodiment, the second sub-coupling portion SCM2 may also be bent twice or more within the first non-display area NDA1. Herein, even as a respective lower and upper contact surface of the second sub-coupling portion SCM2 with the light guide plate LGP and the display panel DP decreases, the second sub-coupling portion SCM2 may still fix the light guide plate LGP and the display panel DP firmly to reduce a phenomenon that the light guide plate LGP is delaminated from the display panel DP.

The first and second sub-coupling portions SCM1 and SCM2 and the light sources LS may be alternately arranged in a zigzag pattern along the first direction DR1, and the first and second sub-coupling portions SCM1 and SCM2 may be disposed so as not to overlap the light sources LS in the second direction DR2.

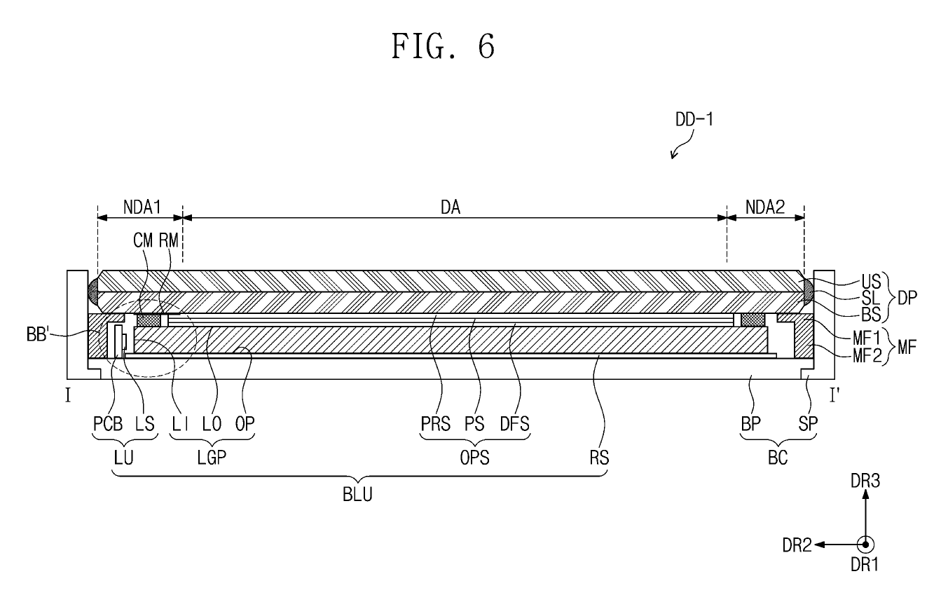

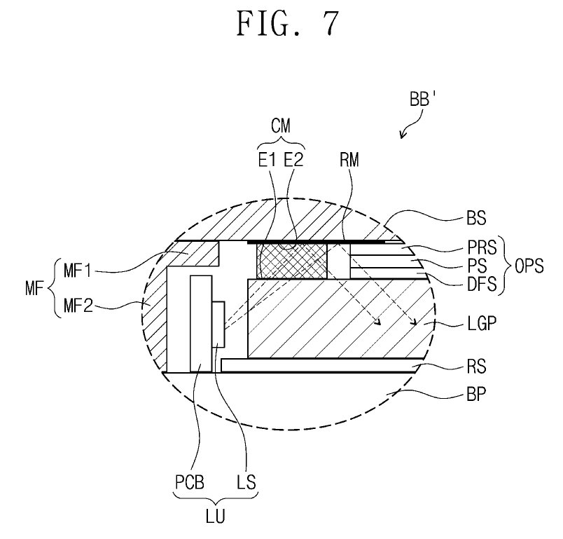

FIG. 6 is a cross-sectional view of still another embodiment of a display apparatus according to the invention, and FIG. 7 is an enlarged cross-section view of the display apparatus at portion BB′ of FIG. 6.

As illustrated in FIGS. 6 and 7, in an embodiment of a display apparatus DD-1 according to the invention, a reflection member RM may be disposed at a second end E2 of a coupling member CM which faces the display panel DP.

The reflection member RM may be disposed at an edge of a rear surface of a display panel DP, which overlaps a first non-display area NDA1. The reflection member RM may be a coating layer coated on the rear surface of the bottom substrate BS with a reflective material, but not limited thereto. In another embodiment, the reflection member RM may be a reflective tape or a printed layer including the reflective material.

Similar to that illustrated in FIG. 4, the coupling member CM of FIG. 6 and FIG. 7 may define lengths thereof which extends along an extension direction (e.g., length) of the non-display area, and may overlap both the first and second non-display areas NDA1 and NDA2. The coupling member CM may be disposed so as to surround the display area DA, when viewed in the top plan view. The coupling member CM may have an overall quadrangular ring shape.

The reflection member RM may be disposed between the coupling member CM and the display panel DP, and may contact a second end E2 of the coupling member CM.

A portion of the reflection member RM other than a portion overlapping the second end E2 may be disposed between the optical sheet OPS and the display panel DP. That is, the reflection member RM may extend further than the coupling member CM and toward the optical sheet OPS to be disposed between the optical sheet OPS and the display panel DP.

A total planar area of the reflection member RM of FIG. 6 and FIG. 7 may be greater than that of the second end E2 of the coupling member CM disposed in the first non-display area NDA1, when viewed in the top plan view, but not limited thereto. In another embodiment, the total planar area of the reflection member RM may be equal to that of the second end E2 of the coupling member RM disposed in the first non-display area NDA1.

The reflection member RM may prevent light incident into the light guide plate LGP at the light incident surface LI thereof from being absorbed in the first non-display area NDA1 of the display panel DP through the coupling member CM. Further, the reflection member RM may reduce or effectively prevent a phenomenon that light incident into the light guide plate LGP leaks to outside the display panel DP through a side surface of the optical sheet OPS. Thus, the display apparatus DD-1 having improved light efficiency may be provided.

One or more embodiment of a display apparatus according to the invention may have a slim design (e.g., having a minimized overall thickness). Also, one or more embodiment of a display apparatus according to the invention may provide an image having improved display quality by improving light efficiency at a light incident side of a light guide plate within the display apparatus.

While the invention has been particularly shown and described with reference to exemplary embodiments thereof, it will be understood by those of ordinary skilled in the art that various changes may be made therein without departing from the scope of the invention as defined by the following claims. Therefore, technical scope of the invention should not be construed as limited to those described in the description, but determined by the appended claims.

What is claimed is:

1. A display apparatus comprising:
a display panel configured to provide an image with light, the display panel including a display area at which the image is generated and displayed, and a non-display area which surrounds the display area; and
a backlight unit which generates and provides the light to the display panel, the backlight unit comprising:
a light guide plate which is disposed under the display panel and guides the light;
a light source which generates and provides the light, the light source disposed at a side of the light guide plate;
a coupling member which couples the display panel to the light guide plate, the coupling member disposed in the non-display area and between the display panel and the light guide plate, wherein the coupling member includes a first end facing the display panel and a second end opposing the first end thereof and facing the light guide plate; and
a reflection member disposed on the first end or the second end of the coupling member.

2. The display apparatus of claim 1, wherein
the non-display area comprises:
a first non-display area extended along the side of the light guide plate at which the light source is disposed, and
a second non-display area which is connected to the first non-display area and extends along remaining sides of the light guide plate to surround the display area, and
the reflection member is disposed in the first non-display area extended along the side of the light guide plate at which the light source is disposed.

3. The display apparatus of claim 2, wherein the light guide plate comprises glass.

4. The display apparatus of claim 3, wherein
the light guide plate comprises:
a light emitting surface which faces the display panel and through which guided light is provided to the display panel;
an opposed surface which is opposite to the light emitting surface; and
a light incident surface which connects the light emitting surface to the opposed surface, the light incident surface at the side of the light guide plate and facing the light source, and
the reflection member disposed in the first non-display area is on the light emitting surface of the light guide plate.

5. The display apparatus of claim 4, wherein the reflection member on the light emitting surface of the light guide plate is between the coupling member and the light emitting surface of the light guide plate and contacts the second end of the coupling member.

6. The display apparatus of claim 5, wherein a total planar area of the reflection member disposed in the first non-display area is equal to or greater than a total planar area of the second end of the coupling member in a top plan view.

7. The display apparatus of claim 2, wherein the reflection member disposed in the first non-display area is on a rear surface of the display panel opposite to a display surface thereof.

8. The display apparatus of claim 7, wherein the reflection member on the rear surface of the display panel is disposed between the coupling member and the rear surface of the display panel and contacts the first end of the coupling member.

9. The display apparatus of claim 8, wherein a total planar area of the reflection member disposed in the first non-display area is equal to or greater than a total planar area of the first end of the coupling member in a top plan view.

10. The display apparatus of claim 2, wherein the coupling member disposed in the non-display area of the display panel surrounds the display area thereof in a top plan view.

11. The display apparatus of claim 2, wherein the coupling member comprises:
a first coupling portion disposed extended in the first non-display area extended along the side of the light guide plate at which the light source is disposed; and
a second coupling portion disposed extended in the second non-display area extended along the remaining sides of the light guide plate to surround the display area.

12. The display apparatus of claim 11, wherein
the light source is provided in plurality spaced apart from each other along the side of the light guide plate to be arranged in a first direction, and
the first coupling portion disposed extended in the first non-display area comprises:
a first sub-coupling portion provided in plurality spaced by a predetermined distance from each other and arranged along the side of the light guide plate at which the light source is disposed to be arranged in the first direction; and
a second sub-coupling portion disposed spaced by a predetermined distance from outermost first sub-coupling portions at opposing ends of the side of the light guide plate at which the light source is disposed,
wherein the second sub-coupling portions at the opposing ends of the side of the light guide plate are each bent at least once to be coupled to the second coupling portion disposed extended in the second non-display area,
wherein in a second direction intersecting the first direction in a top plan view, the first sub-coupling portions arranged spaced apart in the first direction are disposed at spaces defined between the light sources spaced apart from each other in the first direction.

13. The display apparatus of claim 12, wherein in the second direction intersecting the first direction in the top plan view, the first and second sub-coupling portions arranged spaced apart in the first direction do not overlap the light sources arranged spaced apart in the first direction.

14. The display apparatus of claim 1, wherein the reflection member comprises a reflection material including silver (Ag) or aluminum (Al).

15. The display apparatus of claim 1, wherein the reflection member comprises a reflective material and includes a reflection tape or a printed layer.

16. The display apparatus of claim 1, further comprising an optical sheet disposed between the display panel and the light guide plate and including a side which faces the coupling member disposed in the non-display area and between the display panel and the light guide plate.

17. The display apparatus of claim 16, wherein the reflection member is disposed on the second end of the coupling member and extends further than the coupling member to be disposed between the light guide plate and the optical sheet.

18. The display apparatus of claim 16, wherein the reflection member is disposed on the first end of the coupling member and extends further than the coupling member to be disposed between the display panel and the optical sheet.

19. A display apparatus comprising:
a display panel divided into a display area at which an image is displayed with light and a non-display area which surrounds the display area, wherein the non-display area is divided into:
a first non-display area extended along a side of the display area, and
a second non-display area connected to the first non-display area and extending along remaining sides of the light guide plate to surround the display area;
a light guide plate which is disposed under the display panel and guides the light;
a light source which generates and provides the light, the light source disposed adjacent to a side of the light guide plate corresponding to the first non-display area;
a coupling member which couples the display panel to the light guide plate, the coupling member disposed in the non-display area and between the display panel and the light guide plate; and
a reflection member disposed in the first non-display area and between the coupling member and the display panel.

20. The display apparatus of claim 19, wherein the reflection member disposed in the first non-display area and between the coupling member and the display panel comprises a reflective material, the reflection member including a coating layer, a reflection tape or a printed layer.
